(19) United States
(12) Patent Application Publication
(10) Pub. No.: US 2007/0002588 A1
(43) Pub. Date: Jan. 4, 2007

(54) Backlight module light equilibrator

(75) Inventor: Wen-Pao Tseng, Yangmei Taoyuan (TW)

Correspondence Address: TROXELL LAW OFFICE PLLC;SUITE 1404, 5205 LEESBURG PIKE, FALLS CHURCH, VA, 22041, US

(73) Assignee: K-Bridge Electronics Co., Ltd.

(21) Appl. No.: 11/171,415

(22) Filed: Jul. 1, 2005

(51) Int. Cl. F21V 7/04

(52) U.S. Cl. 362/620

(57) ABSTRACT

A light equilibrator provided between light source and optical film of an LCD is essentially comprised of an optical plate, and multiple light guide members disposed on both sides of the optical plate at where in relation to each light source and optical film; the light guide member penetrating into or protruding from the optical plate surface; density, angle or depth varying among light guide members; light being diffused at least twice by the equilibrator before entering into the optical film to effectively distribute the light for the backlight module to emit equilibrated light.

### BACKGROUND OF THE INVENTION

(a) Field of the Invention

The present invention is related to a light equilibrator, and more particularly, to one that is adapted to a direct type backlight module.

(b) Description of the Prior Art

Depending on the design requirements, directly type or side-edge backlight module configuration is selected for an LCD applied in information device. FIG. 1 of the accompanying drawings shows a basic construction of a direct type backlight module configuration, the entire backlight module is comprised of a reflector hood 10, multiple light sources 20, a diffuser plate 30, multiple optical films 40, and a liquid crystal panel 50 arranged in sequence from inside to outside. Wherein, each light source 20 is made in the form of a straight tube, a U-shaped tube, or a snake shaped tube, and all those light sources 20 are distributed with a proper spacing at where between the reflector hood 10 and the diffuser plate 30. Light emitted from each of those multiple light sources 20 constitutes those effects displayed by the liquid crystal module. For those backlight modules generally available in the market, multiple optical films 40 are comprised of combinations of 1˜3 diffuser plate, 0˜2 brightness enhancing film (BEF), and 0˜1 reflective polarizer to diffuse the light passing through and thus to correct the alternatively bright and dark bands created on the liquid crystal module due to the position of the spacing between any two abutted light sources.

Furthermore, the only purpose of the diffuser plate 30 is consistently diffuse the light passing through it, and has very limited results on improving the phenomenon of alternatively bright and dark bands created on the liquid crystal module. Therefore, even certain backlight modules have on purpose extended the spacing between those light sources 20 and the diffuser plate 30 to allow expanded area for the light from each light source 20 to enter into the diffuser plate 30 so to reduce the area of the alternatively bright and dark bands, such a design gives very little effects. Also, the backlight module is thickened, violating the basic design requirements of staying compact.

### SUMMARY OF THE INVENTION

The primary purpose of the present invention is to provide a light equilibrator for the backlight module to evenly irradiate light from the light source towards the liquid crystal panel. Similar to the prior art, the basic configuration of the LCD in the present invention delivers the light source presentation results as a light-emitting object through optical film and liquid crystal panel.

To provide an even active and positive means to eliminate the alternatively bright and dark bands otherwise created on the backlight module of the prior art and offer a solution for more effective distribution of the light emitted form the light source, an equilibrator essentially comprised of an optical plate, and multiple light guide members disposed on both sides of the optical plate at where in relation to each light source and optical film is provided between light source and optical film of an LCD is. The light guide member either penetrates into or protrudes from the optical plate surface. Density, angle or depth varies among light guide members. The light is diffused at least twice by the equilibrator before entering into the optical film to effectively distribute the light for the backlight module to emit equilibrated light.

### BRIEF DESCRIPTION OF THE DRAWINGS

FIG. 1 is a schematic view showing a structure of a backlight module of the prior art.

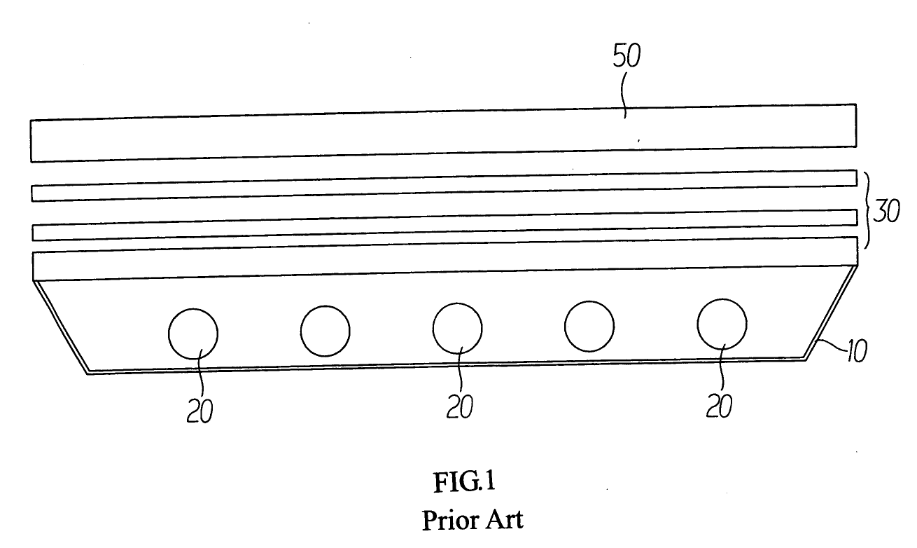

FIG. 2 is a perspective view of a light guide in a first preferred embodiment of the present invention.

FIG. 3 (A) is a perspective view of a light guide in a second preferred embodiment of the present invention.

FIG. 3 (B) is a perspective view of a light guide used in a third preferred embodiment of the present invention.

FIG. 4 is a schematic view showing a structure of a direct type backlight module used in the present invention.

FIG. 5 (A) is a schematic view showing a pattern of light disposition in a direct type backlight module of the present invention.

FIG. 5 (B) is a schematic view showing another patter of light disposition in a direct type backlight module of the present invention.

FIG. 6 is a schematic view showing another structure of a direct type backlight module used in the present invention.

FIG. 7 is a perspective view showing a construction of multiple light sources and an optical plate of the present invention.

### DETAILED DESCRIPTION OF THE PREFERRED EMBODIMENTS

The present invention is related to a light equilibrator provided between light source and optical film of an LCD. The light equilibrator is essentially comprised of an optical plate, and multiple light guide members disposed on both sides of the optical plate at where in relation to each light source and optical film. The light guide member either penetrates into or protrudes from the optical plate surface. Density, angle or depth varying among light guide members so that the light is diffused at least twice by the equilibrator before entering into the optical film to effectively distribute the light for the backlight module to emit equilibrated light.

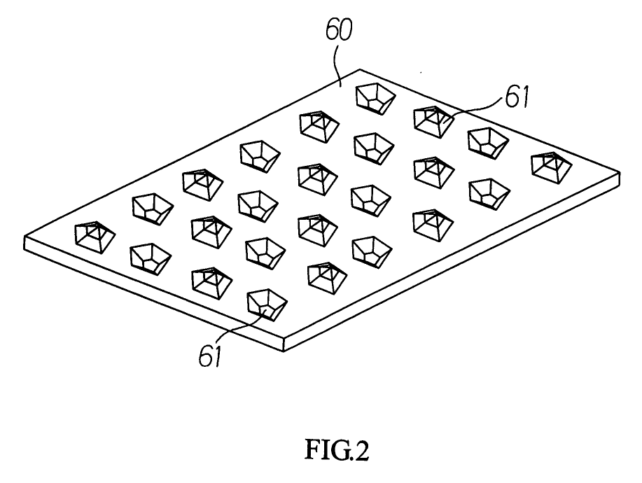

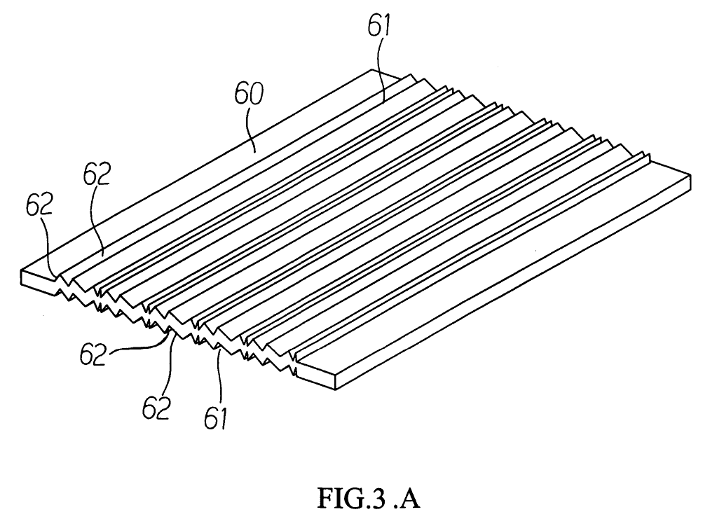

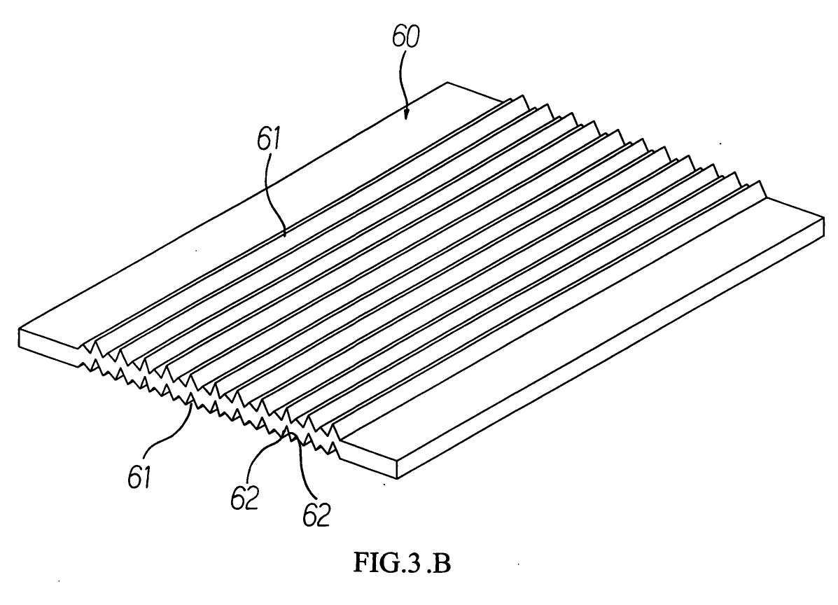

As illustrated in FIG. 2 for a first preferred embodiment of the present invention, multiple light guide members 61 of the light equilibrator are each made in the form of a protruding or recessed polygonal cone. In the first preferred embodiment, the spacing between any two abutted light guide members 61 is not greater than 1 mm, and the height or depth each guide member 61 protruding from or recessed in the optical plate 60 is not greater than 0.5 mm. Alternatively, each light guide member 61 is comprised of multiple protruding or recessed grooves with each groove penetrating into or protruding from a double refractor 62. The double refractor 62 may be disposed such that the angles of both refraction surfaces are different from each other as illustrated in FIG. 3 (A) or such that the depths of both refraction surfaces are different from each other as illustrated in FIG. 3 (B). The protrusion or the recess structure for the light guide member 61 may be designed such that it extends all over the entire optical plate 60 to diffuse the light passing through the optical plate 60. The optical plate 60 may be related to a see-through bar or a white foggy bar made of PC or PMMA added with a diffusion agent such as Silica (SiO₂) or Titania (TiO₂).

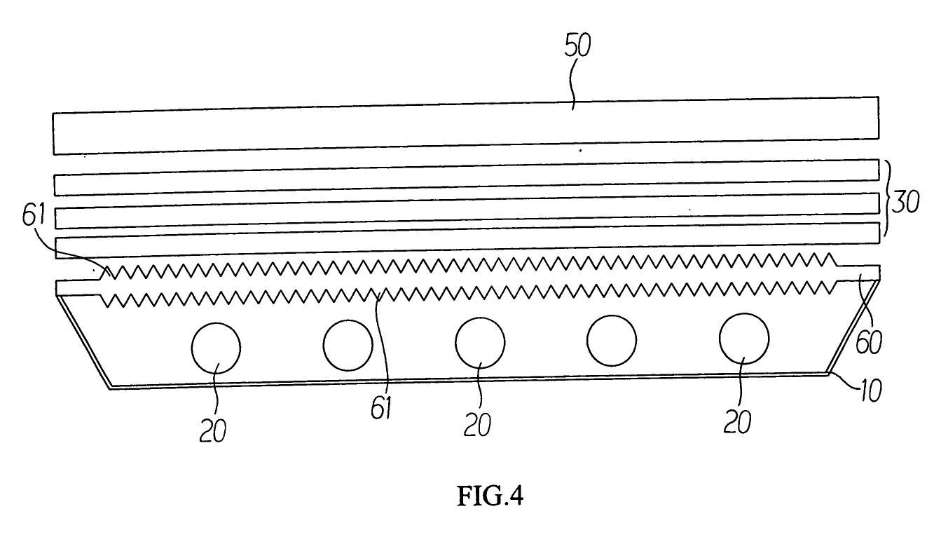

Now referring to FIG. 4 for another preferred embodiment yet of the present invention, an LCD essentially is comprised of a reflector hood 10 containing evenly distributed multiple light sources 20; and the optical plate 60 (in the form of a diffuser plate generally available in the market), an optical films 30 comprised of combinations of 1˜3 diffuser plate, 0˜2 brightness enhancing film (BEF), and 0˜1 reflective polarizer, and a liquid crystal panel 40 arranged in sequence from inside to outside at the opening of the reflector hood 10 to facilitate the light presentation results of those multiple light sources 20 through the optical film 30 and the liquid crystal panel 40. Wherein, each light source 20 is made in the form of a straight tube, a U-shaped tube, or a snake shaped tube, and all those light sources 20 are distributed with a proper spacing at where between the reflector hood 10 and the optical film plate 30.

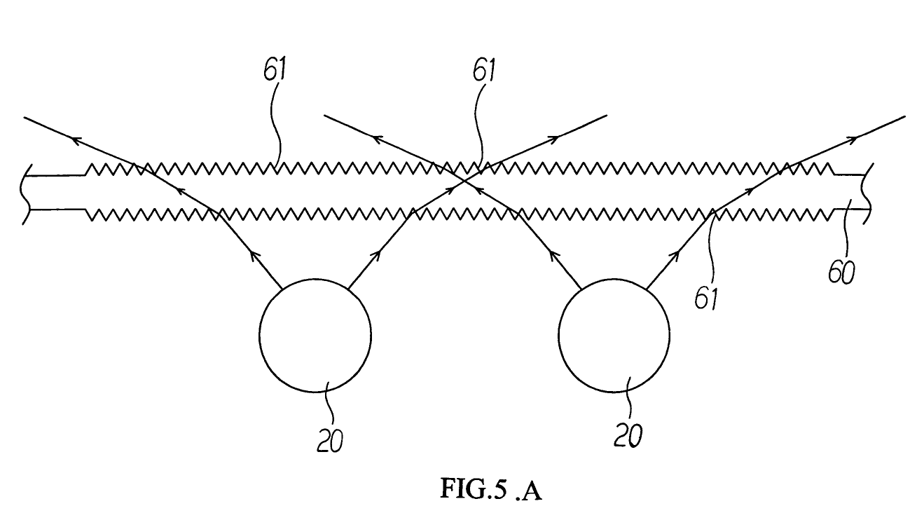

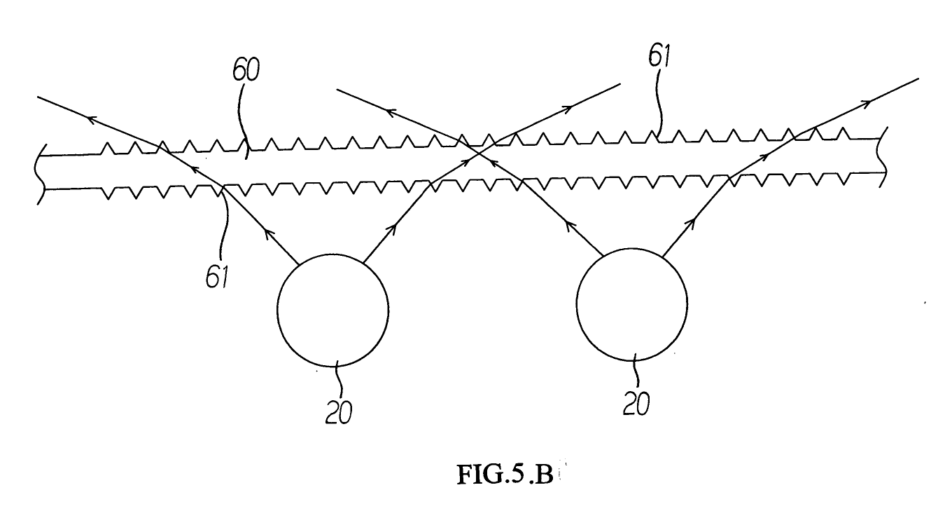

Accordingly, each light guide member 61 is located at where in relation with its corresponding light source 20 by having the optical plate 60 mounted at the opening of the reflector hood 10 before laminating in sequence the optical film 30 and the liquid crystal panel 40 on the upper deck of the optical plate 60. Wherein, as illustrated in FIG. 5(A), light from the light source 20 before entering into the optical film 30 is diffused at least twice by the light guide member 61 through the light equilibrator to provide an even active and positive means for eliminating the alternatively bright and dark bands otherwise created on the backlight module of the prior art and offer a solution for more effective distribution of the light emitted form the light source. The arrangement of those multiple light guide members 61 may be in continuous fashion as illustrated in FIG. 5 (A), or not as illustrated in FIG. 5 (B).

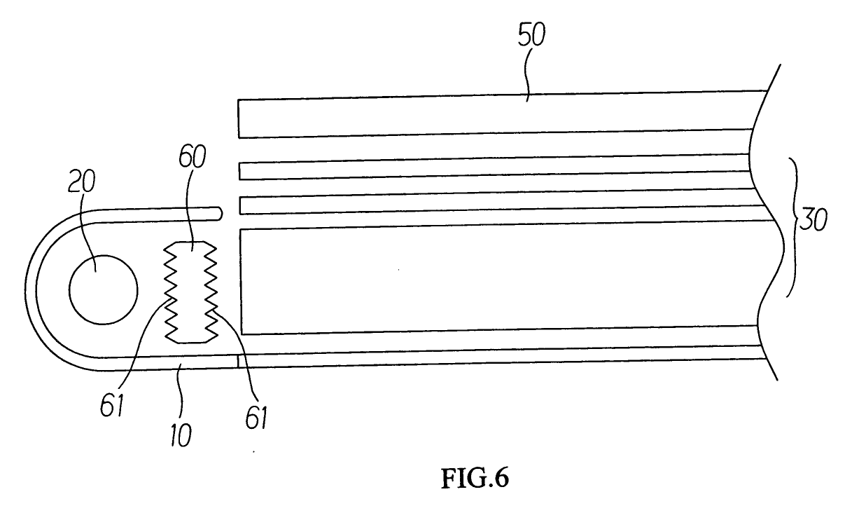

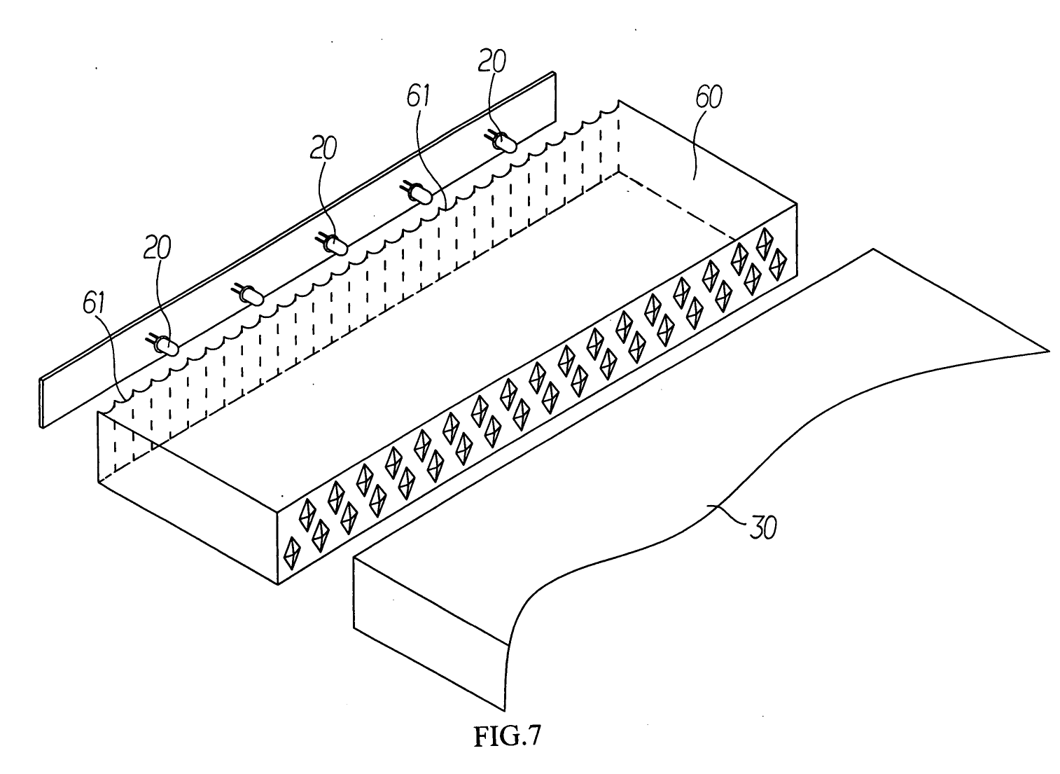

As illustrated in FIGS. 6 and 7 for another basic configuration yet of the LCD, a light inlet surface 61 is provided on the optical plate 60 at where directly aligned at each light source 20, and a light outlet surface 62 is provided at where the optical film 30 of the backlight module is located. The optical film 30 is comprised of combinations of 1˜3 diffuser plate, 0˜2 brightness enhancing film (BEF), and 0˜1 reflective polarizer. In the preferred embodiment, the reflector hood 10 is disposed at the end of the optical film 30 of the backlight module and each light source 20 is disposed on the inner side of the optical film 30 to project the light in the direction facing the optical film 30 before emitting towards the surface of the optical film 30.

Whereas the light outlet surface of the optical plate 60 is at where directly aligned to the end of the optical film 30, the light passing through the optical plate 60 from the light inlet surface 61 of each light source 20 enters into the optical film 30 and the liquid crystal panel to execute the presentation results of the light from the light source 20 for the entire backlight module to produce the expected luminance.

The prevent invention provides an improved structure of a backlight module adapted with a light equilibrator, and the application for a patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A backlight module light equilibrator provided between light source and optical film of an LCD is essentially comprised of an optical plate, and multiple light guide members disposed on both sides of the optical plate at where in relation to each light source and optical film; the light guide member either penetrating into or protruding from the optical plate surface; density, angle or depth varying among light guide members so that the light is diffused at least twice by the equilibrator before entering into the optical film to effectively distribute the light for the backlight module to emit equilibrated light.

2. The backlight module light equilibrator of claim 1, wherein multiple light sources of the LCD are distributed within a reflector hood; the light equilibrator is mounted on the opening of the refractor hood; and the optical film and a liquid crystal panel are laminated in sequence on the upper deck of the light equilibrator.

3. The backlight module light equilibrator of claim 1, wherein multiple light sources of the LCD are distributed within a reflector hood; the light equilibrator is mounted on the opening of the refractor hood; a light inlet surface being disposed on the optical plate of the light equilibrator at where directly aligned at those light sources; a light outlet being disposed at where directly aligned to the end of the optical film; and multiple light guide members being respectively disposed on the light inlet surface and the light outlet surface.

4. The backlight module light equilibrator of claim 1, wherein each light source is made in the form of a straight tube, a U-shaped tube, or a snake shaped tube with all the light sources distributed with a proper spacing at where between the reflector hood and the diffuser plate.

5. The backlight module light equilibrator of claim 1, wherein each light source relates to a LED with all light sources distributed with a proper spacing at where between the reflector hood and the diffuser plate.

6. The backlight module light equilibrator of claim 1, wherein each light guide member is comprised of protruding or recessed polygonal cone or groove extending from the optical plate.

7. The backlight module light equilibrator of claim 1, wherein the optical plate relates to a see-through or white foggy bar.

8. The backlight module light equilibrator of claim 1, wherein the spacing between any two abutted light guide members is not greater than 1 mm.

9. The backlight module light equilibrator of claim 1, wherein the height or depth each guide member protruding from or recessed in the optical plate is not greater than 0.5 mm.
